(19) United States
(12) Patent Application Publication
(10) Pub. No.: US 2008/0205047 A1
(43) Pub. Date: Aug. 28, 2008

(54) Illuminating Device and Illuminating Packaging System

(76) Inventor: James M. Leventhal, Newton Center, MA (US)

Correspondence Address: MINTZ, LEVIN, COHN, FERRIS, GLOVSKY AND POPEO, P.C;ATTN: PATENT INTAKE CUSTOMER NO. 30623, ONE FINANCIAL CENTER, BOSTON, MA, 02111, US

(21) Appl. No.: 11/972,498

(22) Filed: Jan. 10, 2008

Related U.S. Application Data
(60) Provisional application No. 60/898,890, filed on Jan. 31, 2007.

(51) Int. Cl. F21V 33/00

(52) U.S. Cl. 362/155

(57) ABSTRACT

An improved product packaging system for use in containing and/or dispensing one or more products incorporates an illuminating device such that the one or more products housed within the packaging system are enhanced by light emitting from the illuminating device. A housing, container or vessel of the product packaging system is at least partially constructed of one or more translucent or transparent materials that permit light emanating from the illuminating device to transmit or reflect outside of the product packaging system. The translucent or transparent materials further permits visual inspection of the one or more products contained within the packaging system. The light-enhanced product packaging system helps to draw the attention of consumers, or end-users of the one or more products, to the location of the product packaging system on retail shelves and displays and thereby the location of the one or more products contained within the packaging system. The light-enhanced product packaging system further helps to highlight or to visually enhance the product packaging and the one or more products contained within the packaging to attractively market and to distinguish the packaging and the one or more products from other product packaging and products located along retail shelves and displays.

### PRIOR PATENT APPLICATION

This application is a nonprovisional patent application that claims priority to U.S. provisional patent application Ser. No. 60/898,890 filed Jan. 31, 2007, the disclosure of which is incorporated herein in its entirety by reference.

### TECHNICAL FIELD

The invention relates to an improved products packaging system. More particularly, the invention is directed to an illuminating device for incorporating with a packaging system for one or more products to provide an improved packaging system and to promote the products contained therein.

### BACKGROUND OF THE INVENTION

Conventional products packaging is well known. Such packaging systems generally include gift boxes, clam shell-type packages, blister packs, and other means to contain and to display products, such as consumer products, contained within such packaging systems. In many instances, such packaging systems help to promote the sales of products. Prior art packaging systems typically consist of any of a variety of materials, including plastics, paper products and other durable and/or disposable materials.

It is also well known that packaging systems for products and, in particular, consumer products are intended to protect their contents through the use of suitable materials of construction and structural designs that reduce the potential for damage to the products. As mentioned, packaging systems are also well known to promote the sales of products contained within such systems. Packaging systems employ molded or stylized structures, as well as colors, graphics, labels, decorations and other ornamentations, either inside or outside the packaging systems, to enhance the presentation of the packaging system and the product(s) contained within the system to thereby market and promote the product(s) to consumers and end-users.

With the development of a variety of plastics and other suitable materials, products packaging systems often use translucent or transparent materials of construction such that a packaging system itself permits the display of the contained product(s) within its interior to enhance the product(s) and to thereby promote sales of such product(s).

Although the well known products packaging systems, and, in particular, consumer products packaging systems, have been relatively effective in, for instance, protecting products during shipment and display, the challenge remains for manufacturers and other producers of products to employ means, including packaging systems, to better promote their goods such that the products stand out from other similar products and are thereby distinguished from the many different product options that are available today, particularly in all consumer product categories. It is commonly known that, for instance, appealing materials, bright colors, and catchy designs and graphics are all effective means to better promote packaged products at the retail level.

In addition, it is well known that an effective means to promote the sale of packaged products is the use of conventional forms of advertising to promote brand awareness, e.g., the association of a brand with a particular product and its source, or to promote the product itself, such as, for instance, where the associated brand has become ubiquitous. These conventional forms of advertising may consist of television, print media, direct mail, internet and outdoor advertising. It has been documented recently that manufacturers and producers are finding that conventional forms of advertising, such as television and print advertising, have become more expensive due to their mass distribution to the public, and are less and less effective in promoting product sales. Therefore, conventional forms of advertising are requiring manufacturers and producers to expend larger sums of money in order to achieve the sales performance results they desire and had once achieved at lesser expense.

With the development of larger and larger retail stores, with foot prints reaching 200,000 square feet, some consumer product categories can have as many as hundreds of relatively different options of certain products that are available to consumers. Because of the increase in the availability and diversity of a single type of consumer product, it is desirable for manufacturers and producers to use packaging systems such that their products are enhanced and are distinguished from similar products displayed at the retail level.

Therefore, a product packaging system that serves to help to enhance the one or more products contained within the packaging system is desirable to help to enhance the one or more products and to thereby distinguish such products from others.

### SUMMARY OF THE INVENTION

An object of the invention is an improved packaging system for use in containing and/or dispensing one or more products that incorporates an illuminating device within the interior of the packaging system, and/or along the exterior of the packaging system, to illuminate the one or more products within the packaging system.

Another object of the invention is an illuminating packaging system for use in containing and/or dispensing one or more products that illuminates the product(s) while housed within the interior of the packaging system to thereby enhance the display of the product(s) and to promote the sales of such product(s).

A further object of the invention is an improved packaging system for use in containing and/or dispensing one or more consumer products that illuminates the product(s) while housed within the interior of the packaging system to diminish or avoid the limitations and shortcomings of conventional prior art packaging systems of consumer products and to thereby provide an improved means for displaying one or more consumer products and for distinguishing the one or more consumer products from other similar products when displayed for sale at the retail level.

Another object of the invention is an illuminating device constructed and arranged such that the device may be incorporated into a products packaging system for housing, containing and/or dispensing one or more products.

Various aspects of the invention may provide one or more of the following capabilities and/or advantages. A packaging system can be provided that is constructed of relatively low cost materials and includes means of illuminating one or more products contained within the interior of the packaging system. Illuminating one or more products contained while contained within the packaging system can enhance the display of the product(s) and can distinguish the product(s) from other products to thereby promote the sales of such product(s) to consumers. The packaging system can be constructed and arranged as a relatively small packaging system to house one or more relatively small products. The means of illuminating the packaging system according to the invention can include a device comprising one or more light-emitting elements, such as, for instance, one or more lights or light emitting diodes (LEDs). Such light-emitting element(s) can be powered by one or more power sources, such as, for instance, one or more replaceable or rechargeable batteries or one or more solar cells disposed within the interior, or along the exterior, of the packaging system and operatively coupled with the one or more lights or LEDs.

The one or more light-emitting elements can be disposed within the interior of the packaging system, or along the exterior of the packaging system, to illuminate wholly or partially one or more products contained within the packaging system. Alternatively, one or more light-emitting elements can be disposed within the interior of the packaging system, while one or more other light-emitting elements can be disposed along the exterior of the packaging system, to illuminate wholly or partially the one or more products contained within the interior of the packaging system.

The packaging system can further include a housing, container, or vessel into which the illuminating device is wholly or partially incorporated. The housing, container, or vessel can be constructed and arranged to contain and/or to dispense one or more products and can be constructed of a material suitable to permit light to diffuse through the housing, container, or vessel walls, including, but not limited to, translucent and transparent materials. The packaging system housing can have any of a variety of shapes, configurations, and dimensions and can define a cross-sectional profile have any of a variety of shapes, configurations, and sizes.

The illuminating device can comprise one or more light-emitting elements, such as, for instance, one or more lights or light-emitting diodes (LEDs), mounted on, or operatively coupled to, a printed circuit board (PCB) that is configured with programmed and/or programmable logic, e.g., integrated circuit(s), to effect the illuminating of the light-emitting element(s) in accordance with, for instance, a predetermined lighting pattern or cycle, a timed lighting pattern or cycle, a random lighting pattern or cycle, an intermittent lighting pattern or cycle or any lighting pattern or cycle the PCB, alone or in conjunction with other electronic components of the illuminating device, is programmed to effect. The PCB and the light-emitting element(s) are operatively coupled to the one or more power sources.

The PCB further includes electronic components to receive and to further supply electrical power received from the one or more power sources to the PCB, the light-emitting element(s) and any other operable components of the illuminating device as required or desired. At a normal or a baseline state, the illuminating device does not emit light and when one or more electrical circuits of the device is/are completed, the illuminating device emits light. A timing device facilitates the completion of the electrical circuit(s) to cause electrical power to be supplied to the light-emitting element(s) to thereby power the element(s). Such a timing device can include one or more integrated circuits mounted on, or operatively coupled to, the PCB that are programmed or are programmable to complete the electrical circuit(s) to thereby initiate a lighting pattern or cycle as noted above. The integrated circuit(s) can be programmed to control the length of time the illuminating device emits light and the lighting pattern or cycle executed. Further, the integrated circuit(s) can be programmed to provide instructions, e.g., one or more output electrical signals to initiate the onset of the repetition of a lighting pattern or cycle.

The integrated circuit(s) can include an oscillation circuit, wherein the oscillation circuit charges and cuts off electrical current to the illuminating device from one or more electrical power sources to periodically and repeatedly cause the illuminating device to light up and shut off in accordance with an oscillating pattern or cycle. The integrated circuit(s) can be programmed or programmable to count the number of positive electrical signals it receives, and/or to count a given period of elapsing time, e.g., in seconds. Once the integrated circuit(s) detects or counts a default quantity of positive electrical signals, and/or counts a particular number of seconds of the given period of elapsing time via an oscillating circuit, the integrated circuit(s) can cause electrical current to be supplied to the light-emitting element(s) to thereby light such element(s), e.g., in accordance with a pattern or cycle and/or a programmed length of time. Once the light-emitting elements(s) have lit or “flared”, electrical current can be is cut off from the light-emitting element(s) to thereby extinguish lighting, e.g., after a certain period of time for lighting. The integrated circuit(s) may send signal(s) initiating a repetition of an illuminating pattern or cycle, and/or an oscillating circuit of the integrated circuit(s) may set/reset to begin counting a given period of elapsing time.

The integrated circuits can be operatively coupled with a rolling switch that is configured to facilitate or cut off flow of electrical current, supplied from one or more power sources to which the integrated circuits are operatively coupled, when the rolling switch is not disposed, positioned or oriented in a preferred position. When in the preferred position, the rolling switch completes electrical circuits that permit flow of electrical current to the integrated circuits to thereby enable the integrated circuits to implement one or more lighting patterns or cycles of one or more light-emitting elements. The preferred position of the rolling switch can correspond with a certain preferred position of the illuminating device or the illuminating product packaging system into which the rolling switch is incorporated. For instance, the preferred position of the illuminating device or the illuminating product packaging system may be an upright position, while a non-preferred position may be where the device or packaging system are disposed on its side and/or laying in a downward orientation relative to a certain surface of the device or packaging system. In this instance, the preferred position of the rolling switch can correspond to the preferred position of the device or the packaging system such that when the device or the product packaging system is in the preferred position, the rolling switch is as well in its preferred position and can facilitate flow of electrical current to the integrated circuits. In this manner, when the device or the packaging system is not in its preferred position and lighting is not required or desired, the rolling switch is simultaneously not in its preferred position to complete electrical circuits. The rolling switch can thereby be used to prevent lighting of the illuminating device or the illuminating product packaging system when lighting is not required or desired, such as during storage or shipping, such that electrical power of the power sources is conserved.

The illuminating device, comprising the light-emitting element(s), the power source(s), the PCB and the integrated circuit(s) as described above, can further include a protective housing. Such protective housing can include a completely enclosed housing or a partially enclosed housing, depending upon the application in which the illuminating device is incorporated. The housing can have a relatively small size with respect to its overall dimensions such that the illuminating device contained within the housing can be incorporated into a relatively small packaging system. In this case, the configuration and arrangement of the light-emitting element(s), the power source(s), the PCB, and the integrated circuit(s) is such that these elements are mounted or connected to one another, and/or are arranged relative to one another, such that the interior of a small housing can receive and contain these elements. In addition, the housing can be constructed and arranged to permit access to the elements contained therein, such as, for instance, the one or more batteries or solar cells, e.g., to replace or to properly dispose of such power source(s). The housing of the illuminating device, and/or the configuration and arrangement of the elements of the illuminating device, can be constructed and arranged to permit the illuminating device to be disposed within, or along the exterior of, any of a variety of types or configurations of a packaging system in addition to any packaging system disclosed below.

The illuminating device may be constructed and arranged to permit its positioning within the interior of a packaging system, or to be attached in some manner to the exterior of the packaging system. Alternatively, the illuminating device may be constructed and arranged such that a portion of the illuminating device connects with a packaging system such that a portion of the device is disposed exterior to the interior of the packaging system and the remaining portion of the device is disposed within the packaging system interior. In any of these cases, the illuminating device emits light to illuminate one or more portions of the one or more products while the product(s) are contained within the packaging system.

Alternatively, the elements of the illuminating device, namely, the light-emitting element(s), the power source(s), the PCB and/or the integrated circuit(s) can each be configured as a separate component relative to the other elements with each element disposed, for instance, within the interior of the packaging system at a different location or along a different portion of the packaging system interior while being operatively coupled to one another to facilitate illuminating. Further, in this case, some of the elements can be located along the exterior of the packaging system, while other elements can be disposed within the interior of the system. As mentioned, in such alternative configurations and arrangements, the elements of the illuminating device are disposed and configured to illuminate one or more portions of the one or more products contained within the packaging system, and/or to illuminate similar or different portions of the product(s).

These and other advantages and/or advantages of the invention, along with the invention itself, will be more fully understood after a review of the following figures and detailed description.

### BRIEF DESCRIPTION OF THE DRAWINGS

FIG. 1A is a perspective view of an interior of one aspect of the invention providing an illuminating device;

FIG. 1B is a perspective view of the interior of the illuminating device shown in FIG. 1A;

FIG. 2 is a plan view of an alternative layout of components of the illuminating device shown in FIGS. 1A and 1B;

FIG. 3A is a schematic diagram of electrical circuits of one or more integrated circuits of the illuminating device shown in FIGS. 1A and 1B and FIG. 2;

FIG. 3B is a graphical representation of an oscillating lighting cycle or pattern facilitated by the electrical circuits shown in and described with reference to FIG. 3A;

FIGS. 4A and 4B are perspective views of another aspect of the invention providing a product packaging system incorporating the illuminating device shown in FIGS. 1A and 1B and in FIG. 2;

FIG. 4C are cross-sectional views of a variety of cross-sectional profiles that a housing, container or vessel of the product packaging system shown in FIGS. 4A and 4B may define;

FIG. 4D is a perspective side view of the packaging system shown in FIGS. 4A and 4B;

FIGS. 5-6 are perspective views of the packaging system shown in FIGS. 4A-4D;

FIG. 7A-7C are perspective views of the packaging system shown in FIGS. 4A-4D and FIGS. 5 and 6 configured to emit light in a substantially downward orientation;

FIGS. 8A and 8B are perspective views of the packaging system shown in FIGS. 4A-4D and FIGS. 5 and 6 further configured to house a pressurized cylinder or container;

FIG. 9 illustrates a method of lighting the illuminating device shown in FIGS. 1A and 1B and thereby lighting the packaging system shown in FIGS. 4A-4D, FIGS. 5 and 6, and FIGS. 8A and 8B according to a lighting pattern or cycle; and

FIG. 10 is a block flow diagram illustrating another aspect of the invention providing a method of illuminating a device or product packaging system.

### DETAILED DESCRIPTION OF PREFERRED EMBODIMENTS

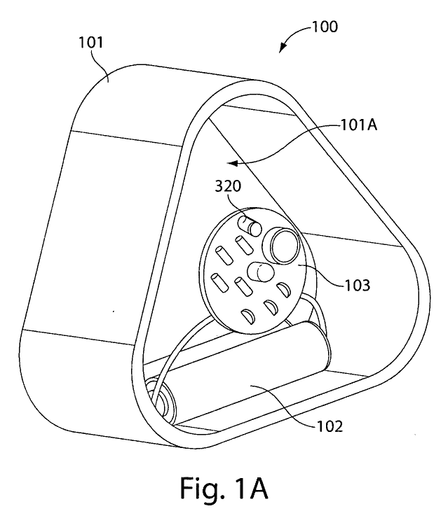

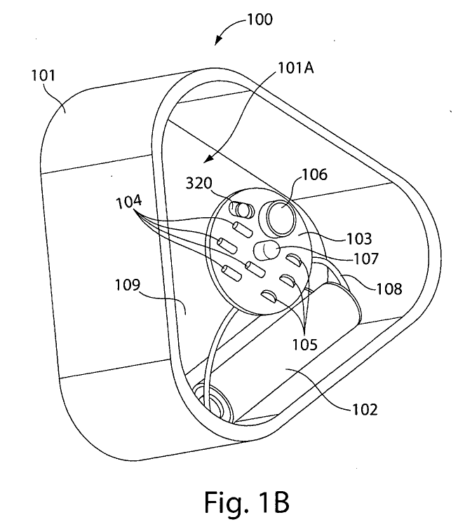

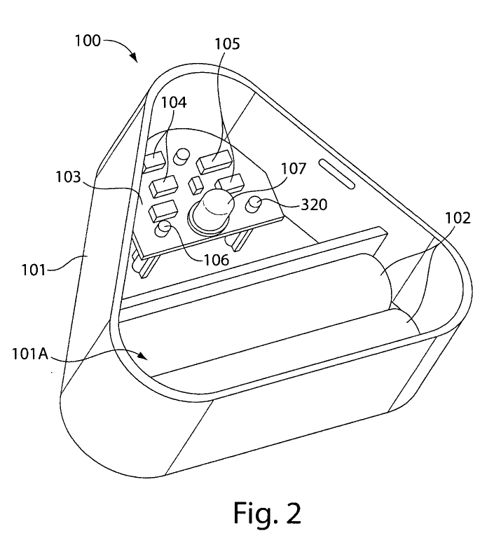

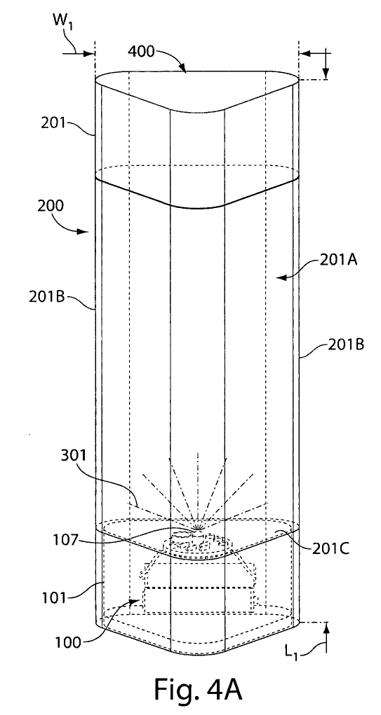

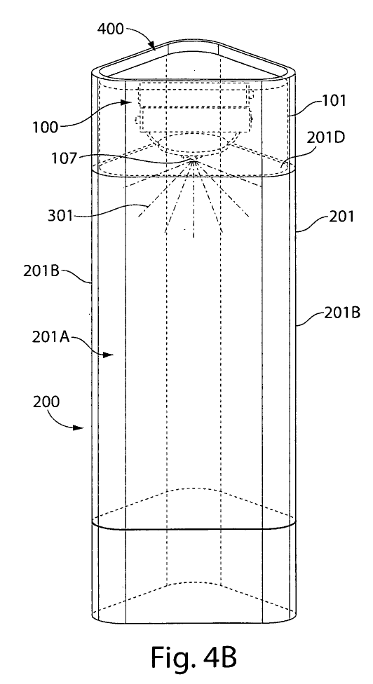

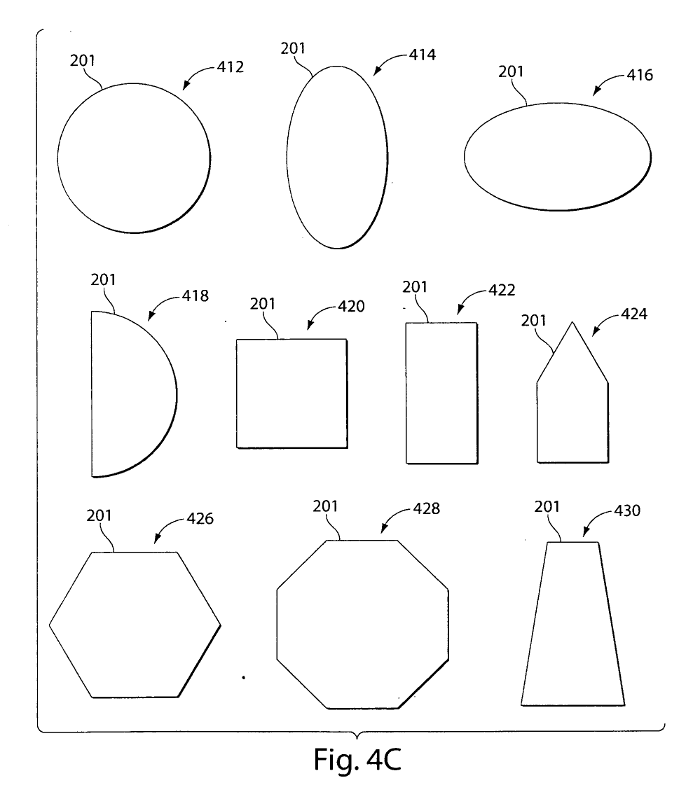

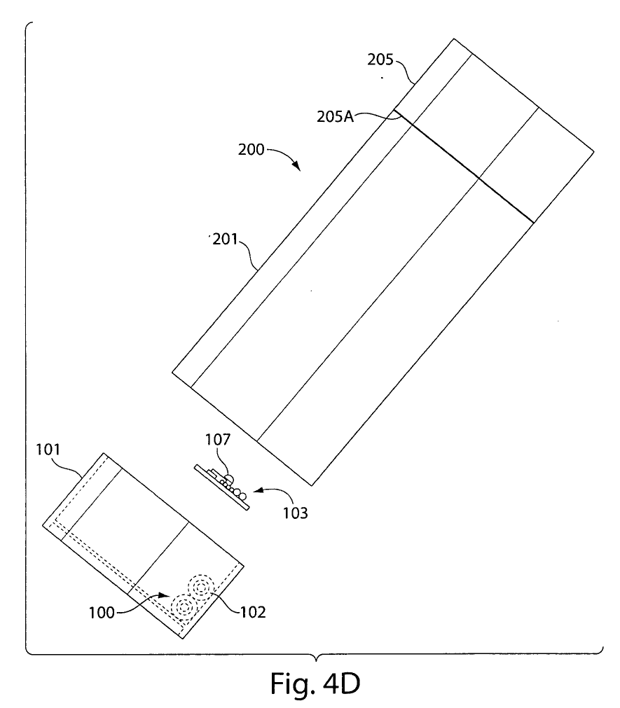

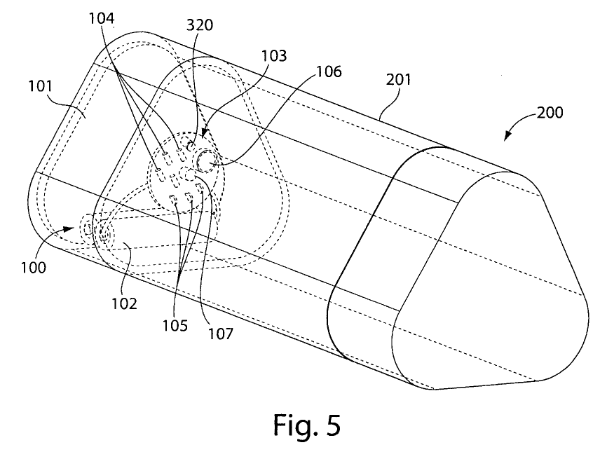

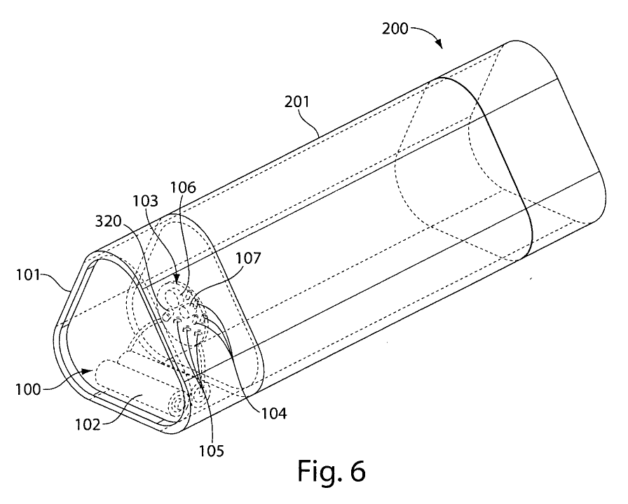

Referring to FIGS. 1A and 1B, in an aspect, the invention provides an illuminating device 100 for use in a product packaging system. In a preferred embodiment of the invention, the device 100 includes a housing 101, one or more power sources 102, a printed circuit board 103, one or more light-emitting device(s) 107, and other electrical components and connections to facilitate one or more electrical circuits that deliver electrical signals to the printed circuit board 103 to effect illuminating of the device 100. Referring to FIGS. 4A thru 4D and FIGS. 5 and 6, in another aspect, the invention includes an illuminating product packaging system 200 constructed and arranged to incorporate one or more illuminating devices 100 described below with reference to FIGS. 1A and 1B and FIG. 2. The one or more illuminating devices 100 may be disposed wholly or partially within an interior of a housing, container or vessel 201 of the packaging system 200, and/or may be connected to an exterior portion of such housing, container or vessel 201.

As shown in FIGS. 1A and 1B, the housing 101 of the illuminating device 100 is constructed and arranged such that the printed circuit board (PCB) 103 and the one or more power source(s) 102 are received by and contained within the housing 101. The housing 101 includes a chamber-like area 101A having dimensions and defining an interior volume to contain and/or to surround the PCB 103, the power source(s) 102, and any other electrical components and connections to operatively couple the power source(s) 102 with the PCB 103 to thereby help to facilitate power to the light-emitting device(s) 107. As described below with reference to FIGS. 5 and 6, the housing 101 may be configured and sized such that the housing 101 mounts or connects to a portion of the product packaging system 200 to thereby permanently or removably mount or connect the illuminating device 100 to the packaging system 200. The housing 101 may be a completely or a partially closed structure. Having a closed structure, the housing 101 may further include one or more releasable walls or panels (not shown) to facilitate access to the interior of the housing 101 and thereby access to the PCB 103, the power source(s) 102 and other components of the illuminating device 100 residing therein, e.g., to repair, replace and/or dispose of any components of the illuminating device 100.

Still referring to FIGS. 1A and 1B, the illuminating device 100 further includes the light-emitting element(s) 107 and one or more integrated circuits 106, all operatively coupled to the PCB 103. In addition, the integrated circuit(s) 106 are operatively coupled to the light-emitting element(s) 107. In the preferred embodiment, the integrated circuits(s) 106 and the light-emitting element(s) 107 are operatively mounted to the PCB 103, as shown in FIG. 1B. Alternatively, in other embodiments, one or more of the light-emitting element(s) 107 may be operatively coupled with the PCB 103 and the integrated circuit(s) 106, while one or more of the light-emitting element(s) 107 may be connected or mounted to one or more other portions of the illuminating device 100, e.g., one or more walls that define the housing 101 and the chamber-like area 101A. In addition, as described below, in alternative embodiments, one or more of the light-emitting elements 107 may be connected to one or more portions of the product packaging system 200 shown in FIGS. 4A thru 4D and FIGS. 5 and 6, while operatively coupled with the PCB 103 and the integrated circuit(s) 106.

The light-emitting element(s) 107 include, but are not limited to, a surface-mount and/or elevated type light or light emitting diode (LED). The invention is not limited in this respect and anticipates that the illuminating device 100 may include one or more other types of light-emitting elements 107 including, but not limited to, one or more traditional electrical light bulbs, fluorescents, solar cells or other light-emitting devices.

The PCB 103 and the power source(s) 102 are operatively coupled together through one or more electrical connectors or connections 108 such that the power source(s) 102 supply electrical power to the PCB 103, e.g., through one or more resistors 104 and through one or more capacitors 105. In this case, the resistor(s) 104 and the capacitor(s) 105 are operatively coupled to the power source(s) 102 and to the PCB 103. As shown in FIG. 1B, in the preferred embodiment, the resistor(s) 104 and the capacitor(s) 105 are mounted directly to a surface of the PCB 103.

The connection of the power source(s) 102 to the PCB 103 via one or more electrical connectors or connections 108 supplies electrical power, e.g., DC electrical current, to effect illuminating of the light-emitting element(s) 107 and thereby to effect illuminating of the device 100. The power source(s) 102 may include, but are not limited to, one or more rechargeable or replaceable batteries or solar cells. The invention is only limited in this respect to sources of power 102 that would be relatively small in comparison to the housing 101, and/or in comparison to the product packaging system 200 with which the illuminating device 100 is incorporated, in order to help to avoid any limitations to the illuminating device 100 and/or the packaging system 200 with respect to its size and its aesthetic value. Due to the cost, weight and aesthetic limitations of the illuminating device 100 and/or the product packaging system 200, in the preferred embodiment, the illuminating device 100 includes one or more power sources 102 that are relatively small and low-cost, such as one or more disposable batteries 102, to provide DC power to the PCB 103.

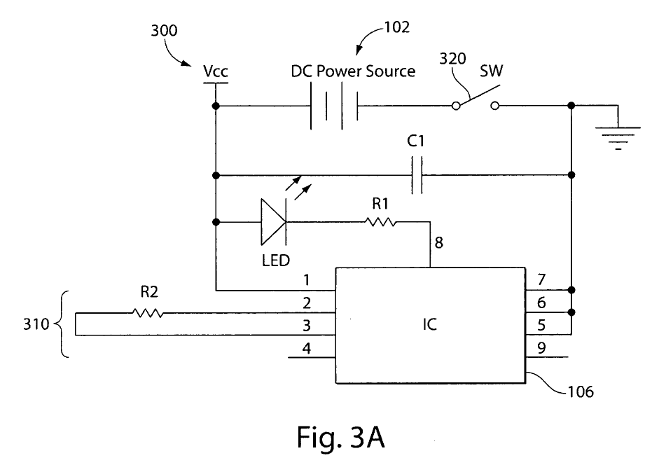

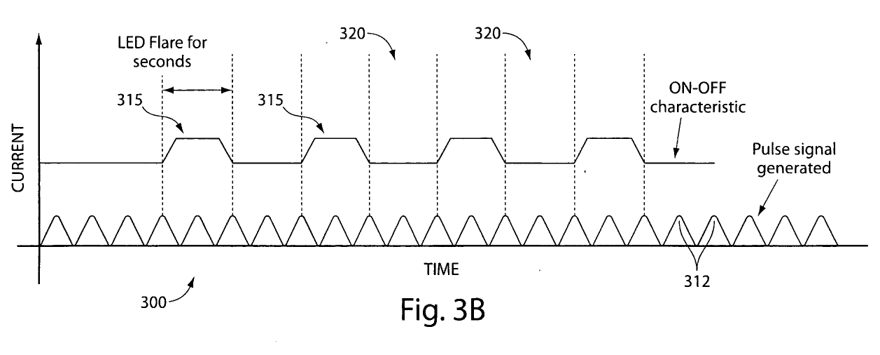

The integrated circuit(s) 106 and/or the PCB 103 are configured with programmed or programmable logic such that a lighting pattern or cycle is facilitated during which the light-emitting element(s) 107 are lit up and distinguished in accordance with the lighting pattern or cycle. Such lighting patter or cycle may include, but is not limited to, a predetermined lighting pattern/cycle, a timed lighting pattern/cycle, a random lighting pattern/cycle, an intermittent lighting pattern/cycle, and/or any lighting pattern/cycle that the PCB 103 and/or the integrated circuit(s) 106 may be programmed or programmable to execute. In addition, as described in detail below with reference to FIGS. 3A and 3B, a rolling switch 320 is mounted to the PCB 103 and is operatively coupled with the integrated circuit(s) 106 and the power source(s) 102 such that the rolling switch 320 facilitates or cuts off electrical current supplied from the power source(s) 102 to the PCB 103 and the integrated circuit(s) 106 to thereby help to conserve electrical power of the power source(s) 102 when illuminating the light-emitting element(s) 107 is not required or desired.

Referring to FIG. 2, a top plan view of the PCB 103 is shown illustrating an alternative lay-out of the components operatively coupled to the PCB 103. The invention is not limited in this respect and envisions that alternative lay-outs of the components discussed above are possible to directly or indirectly operatively couple such components with the PCB 103. In addition, the invention anticipates that other arrangements and configurations of the PCB 103 relative to the power source(s) 102, the connectors or connections 108, and/or the housing 101A are possible.

Referring to FIG. 3A, in the preferred embodiment, the PCB 103 and/or the integrated circuit(s) 106 effect illuminating of the light-emitting element(s) 107, as mentioned, in accordance with one or more illuminating patterns or cycles. FIG. 3A illustrates electrical circuits 300 to facilitate an illuminating cycle or pattern the integrated circuit(s) 106 are programmed or are programmable to enact to cause the light-emitting element(s) 107 to light in accordance with such lighting pattern or cycle. In the preferred embodiment, the PCB 103 and/or the integrated circuit(s) 106 enact an oscillating lighting pattern or cycle whereby the light-emitting element(s) 107 light up and extinguish in a periodic and repeated pattern or cycle. The circuits 300 shown in FIG. 3A, and the graphical representation of a lighting pattern or cycle shown in FIG. 3B, are disclosed with reference to an oscillating lighting pattern or cycle; however, as noted above, the invention is not limited in this respect and anticipates other possible lighting patterns or cycles.

When the PCB 103 is operatively coupled with the power source(s) 102, electrical current flows from the power source(s) 102 to the integrated circuit(s) 106 along circuit pattern(s) terminating at point 1 of the integrated circuit(s) 106, as shown in FIG. 3A. Receiving electrical current causes the integrated circuit(s) 106 to automatically set/reset its setting to begin an illuminating cycle or pattern. Circuit line C1 filters any noise of the electrical current flow before the integrated circuit(s) 106 receive the electrical power. An oscillating circuit 310 is defined by circuit R2 and points 2 and 3 of the integrated circuit(s) 106 and serves as a counter to count a given period of elapsing time, e.g., in seconds, such as, for instance, between and/or during periods when the light-emitting element(s) 107 are lit up or dark. A given period of elapsing time the oscillating circuit 310 counts may be any of a range of timeframes, and is preferably a timeframe of from about 15 seconds to about 25 seconds. In addition, a given period of elapsing time the oscillating circuit 310 counts may be the duration of time between one period of lighting the light-emitting element(s) 107 and a subsequent period of lighting the element(s) 107.

In the preferred embodiment, the oscillating circuit 310 counts a given period of elapsing time, e.g., about 15 seconds or about 25 seconds, between instances when electrical current is provided to the light-emitting element(s) 107 that causes the element(s) to light up or “flare.” Once the oscillating circuit 310 has counted a given period of elapsing time, the oscillating circuit 310 opens and the integrated circuit(s) 106 at point 8 output pulse-width modulation (PWM) signal(s) to facilitate electrical current flow to the light-emitting element(s) 107. The light-emitting element(s) 107 thereby light up or “flare” for a given amount of time, e.g., about 2 or about 3 seconds. R1 controls the electrical current flow to the light-emitting element(s) 107 during light up or “flare” of the element(s) 107. Circuit R1 controls the flow of electrical current to the light-emitting element(s) 107. Once electrical current is supplied to the lighting element(s) 107, the oscillating circuit 310 begins to count another given period of elapsing time, e.g., in seconds, and, at the expiration of the given period of elapsing time, the oscillating circuit 310 opens to facilitate electrical current to the light-emitting element(s) 107 at the expiration of the given period of elapsing time. In this manner, the oscillating circuit 310 periodically and repeatedly facilitates flow of electrical current to the light-emitting element(s) 107 to thereby intermittently cause the element(s) 107 to light or flare in an oscillating pattern or cycle.

As shown in FIG. 3B, operation of the electrical circuits 300 described above with reference to FIG. 3A is shown graphically to illustrate the oscillating or intermittent lighting pattern or cycle of the light-emitting element(s) 107 that the PCB 103 and/or the integrated circuit(s) 106 enact. Once the integrated circuit(s) 106 receive electrical current as described above with reference to FIG. 3A, the integrated circuit(s) 106 periodically output the PWM signals 312 to the light-emitting element(s) 107 to thereby intermittently provide electrical power to the light-emitting device(s) 107 such that the light-emitting device(s) 107 light up for a period of time 315, e.g., about 2 to about 3 seconds, and then shut-off for another period of time 320 during which the oscillator circuit 310 counts a given period of elapsing time as described above. The integrated circuit(s) 106 only stops generating the oscillation or PWM output signals when the power source(s) 102 are disconnected from the lighting circuits 300. When the power source(s) 102 are operatively connected to the lighting circuits 300, the integrated circuit(s) 106 output the oscillation or PWM signals.

With further reference to FIG. 3A, the electrical circuits 300 may be further configured and/or programmed with a rolling switch (SW) 320 that is configured to facilitate flow of electrical current from the power source(s) 102 to the electrical circuits 300 and the integrated circuit(s) 106 by completing the electrical circuits 300. The rolling switch (SW) 320 is a conventional rolling switch that is well known in the art and serves to complete the electrical circuits 300 to thereby facilitate automatic flow of electrical current from the power source(s) 102. The rolling switch 320 may be surface-mounted to the PCB 103 and is operatively coupled to the integrated circuit(s) 106 such that when the rolling switch 320 completes the circuits 300, electrical current flows to the integrated circuit(s) 106. Where the rolling switch 320 is not positioned to complete the electrical circuits 300, as shown in FIG. 3A, the circuits 300 are not complete and the flow of electrical current from the power source(s) 102 is cut off. The rolling switch 320 is configured to complete the electrical circuits 300 when the illuminating device 100 is disposed at one or more positions, e.g., an upright position, to thereby dispose the rolling switch 320 at a first position that will enable the rolling switch 320 to complete the circuits 300 and facilitate automatic flow of electrical current from the power source(s) 102. When the illuminating device 100 is disposed at other positions, e.g., at a sideway position or orientation, the rolling switch 320 is thereby disposed at a second or other position that prevents the rolling switch 320 from completing the circuits 300 and, as a result, electrical current from the power source(s) 102 is cut-off and lighting of the light-emitting element(s) 107 is prevented. In this manner, the product packaging system 200 can be disposed at a particular position or orientation to prevent lighting of the light-emitting element(s) 107 and to thereby minimize or prevent unintended power depletion of the power source(s) 102 when lighting of the light-emitting element(s) 107 is not required or desired.

In the preferred embodiment, where the illuminating device 100 is alone and free-standing or is incorporated with the product packaging system 200, described below with reference to FIGS. 4A thru 4D and FIGS. 5 and 6, the rolling switch 320 completes the electrical circuits 300 when the illuminating device 100 and/or the product packaging system 200 is disposed at an upright position, as shown in FIGS. 4A and 4B, to facilitate electrical current flow and thereby lighting of the light-emitting element(s) 107, while the rolling switch 320 does not complete the electrical circuits 300 when the illumination device 100 and/or the product packaging system 200 is disposed at a sideway position or orientation, as shown in FIGS. 5 and 6. For instance, the illuminating device 100 and the product packaging system 200 may be disposed at a sideway position or orientation during installation of the illuminating device 100 with the product packaging system 200 and/or during packing, shipping and/or storing of the product packaging system 200 in order to prevent unintended lighting of the light-emitting element(s) and thereby unintended depletion of the electrical power supply of the power source(s) 102. The rolling switch 320 thereby enables conservation of the electric power of the illuminating device 100 and the product packaging system 200 and facilitates lighting of the light-emitting element(s) 107, e.g., during intended use and operation, until electric power of the power source(s) 102 is depleted.

The invention is not limited in this respect and envisions that other configurations of the electrical circuits 300 and/or the rolling switch 320 are possible to provide electrical current to the light-emitting elements(s) 107 in accordance with any of a variety of lighting patterns or cycles and when the illuminating device 100 and/or the product packaging system 200 are disposed at any of a variety of positions or orientations.

Referring to FIGS. 4A and 4B, in another aspect, the invention provides the product packaging system 200 including a housing, container or vessel 201 and the illuminating device 100 shown in and described with reference to FIGS. 1A thru 2. The housing, container or vessel 201 is constructed and arranged to define an interior chamber 201A having a configuration and defining a volume to contain or house one or more products. The housing, container or vessel 201 further includes along one of its ends, or along a portion of the housing, container or vessel 201, an opening device 205, e.g., a screw-top or a snap-lock cap or lid, constructed and arranged to releasably connect or secure to the housing, container or vessel 201 and to couple with an opening 205A of the housing, container or vessel 201. The opening device 205 is further constructed and arranged to at least substantially cover the opening 205A, e.g., prevents penetration of objects and substances through the opening 205A into the interior chamber 201A and prevents one or more products contained within the interior chamber 201A from passing through the opening 205A. The opening 205A is configured and is sized to provide fluid communication between the interior chamber 201A and an area external to the housing, container or vessel 201. In some embodiments, the opening 205A enables dispensing of one or more products or articles contained within the housing, container or vessel 201. In other embodiments, the housing, container or vessel 201, and/or the packaging system 200, may be further constructed and arranged to dispense the one or more products contained therein.

The one or more products may include any of a variety of articles or substances including, but not limited to, consumer products that are sold, for instance, at a retail level to consumers and end-users. Such consumer products may include, but are not limited to, personal care and grooming products. In the preferred embodiment of the invention, the housing, container or vessel 201 is constructed and arranged to contain and to dispense any of a variety of personal care and grooming products, including, but not limited to, fluid substances, such as, for example, shaving gel or cream, skin moisturizer, lotion or after-shave, shower and bath soaps or gels, hair shampoo or conditioner, body spray, deodorants, antiperspirants; solid or semi-solid substances, such as, for example, deodorants, antiperspirants, and soaps; and any other substances used for personal care and/or personal grooming. The invention is not limited this respect and envisions that the housing, container or vessel 201 and the packaging system 200 may be employed to contain, house and/or dispense any of a variety of consumer products, including articles of manufacture and gaseous, fluid, solid and semi-solid substances.

The housing, container or vessel 201 may further include, if necessary or desired, any of a variety of devices, mechanisms, structures or other means to position, mount, or connect one or more articles or substances within the interior chamber 201A in order to help the housing, container or vessel 201 to contain or house, and in some instances to dispense, any such articles or substances.

As shown in FIGS. 4A and 4B, in the preferred embodiment, the housing, container or vessel 201 defines the interior chamber 201A such that the housing, container or vessel 201 is a hollow member. The housing, container or vessel 201 may define any of a variety of shapes, sizes and configurations as well as may define any of a variety of cross-sectional profiles. In addition, in the preferred embodiment, the housing, container or vessel 201 is substantially an elongate structure whereby the length L₁ of the structure is larger than the width W₁ of the structure. Further, in the preferred embodiment, as shown in FIGS. 4A and 4B, the housing, container or vessel 201 of the packaging system 200 defines a triangular-shaped cross-sectional profile 400 such that the housing, container or vessel 201 along its length L₁ is triangular. The invention is not limited to the housing, container or vessel 201 with a triangular-shaped cross-sectional profile and envisions that the housing, container or vessel 201 may have a cross-sectional profile of any of a variety of shapes, sizes and configurations to thereby define the housing, container or vessel 201 with any of a variety of shapes, sizes, and configurations, as well as may have any of a range of dimensions.

Referring to FIG. 4C, the invention anticipates that the housing, container or vessel 201 may define along its whole or partial length L₁ one or more cross-sectional profiles including, but not limited to, a circular cross-sectional profile 412, as well as an oval 414, an elliptical 416, a semi-circle 418, a square 420, a rectangular 422, a pentagon 424, a hexagon 426, an octagon 428, a trapezoid 430 or any other shaped cross-sectional profile to define the housing, container or vessel 201 with one or more particular shapes or configurations and to thereby construct the packaging system 200 with any required or desired shapes or configurations.

In the preferred embodiment, the housing, container or vessel 201 is constructed of a material suitable to provide durability to the packaging system 200. Additionally, and/or alternatively, in some instances, the housing, container or vessel 201 is constructed of a material suitable to prevent or to inhibit water penetration into the interior chamber 201A. Additionally, and/or alternatively, in other instances, the housing, container or vessel 201 is constructed of a material suitable to enable a light produced from the light-emitting element(s) 107 of the illuminating device 100 to be at least partially emitted through one or more walls 201B of the housing, container or vessel 201 and/or to be visible from an area external to the housing, container or vessel 201. Suitable materials for construction of the housing, container or vessel 201 and/or the packaging system 200 also may include materials that help to enable the packaging system 200 to be relatively lightweight and/or of a weight that is conducive for manual manipulation by end-users, and/or materials that may receive surface treatments along an exterior and/or an interior of the housing, container or vessel 201, such as, for instance, printing information along the housing, container or vessel 201 exterior and/or wrapping or treating the exterior and/or the interior with one or more materials. Suitable materials may include, but are not limited to, transparent or translucent plastics, glass, and other polymers.

As shown in FIG. 4A, the illuminating device 100 described above and in reference to FIGS. 1A thru 2 may be disposed within the packaging system housing, container or vessel 201 along a bottom portion 201C of the housing, container or vessel 201, e.g., releasably mounted or connected to the bottom portion 201C. In this case, the light-emitting element(s) 107 may be mounted or connected to the PCB 103 along its surface in order a substantial portion of the light-emitting element(s) projects away from the PCB 103 surface, such that, where the illuminating device 100 is mounted or connected to the bottom portion 201C of the housing, container or vessel 201, the light-emitting element(s) 107 project from the PCB 103 in a substantially upward orientation relative to the PCB 103. When the light-emitting element(s) 107 light up, light 301 projects into the interior chamber 201A in a substantially upward orientation. When the housing, container or vessel 201 houses or contains an article or substance, depending upon the physical properties of such article or substance, the bottom-mounted light-emitting element(s) 107 would emit light 301 that projects in a substantially upward orientation and through and/or around the article or substance contained therein to thereby illuminate the article or substance such that it may be visible and/or visually enhanced. In this case, the housing, container or vessel 201 may be constructed of one or more materials that permit the light emitted from the light-emitting element(s) 107 to be at least partially transmit or reflect through the bottom portion 201C, e.g., and optionally one or more walls 201B, of the housing, container or vessel 201 and to be visible from an area external to the housing, container or vessel 201. For instance, with the bottom portion 201C, and optionally one or more walls 201B, constructed of one or more translucent or transparent plastics, the light emitted from the light-emitting element(s) 107 would light up, for instance, an article or a fluid substance housed or contained within the housing, container or vessel 201 such that the article or fluid substance would be light-enhanced and the lighted article or the lighted fluid substance would be visible from an area external to the housing, container or vessel 201.

Alternatively, or additionally, as shown in FIG. 4B, the illuminating device 100 described above and in reference to FIGS. 1A thru 2 may be disposed within the packaging system housing, container or vessel 201 along a top portion 201D of the housing, container or vessel 201, e.g., releasably mounted or connected to the bottom portion 201D. In this case, the light-emitting element(s) 107 may be mounted or connected to the PCB 103 along its surface in order a substantial portion of the light-emitting element(s) projects away from the PCB 103 surface, such that, where the illuminating device 100 is mounted or connected to the top portion 201D of the housing, container or vessel 201, the light-emitting element(s) 107 project from the PCB 103 in a substantially downward orientation relative to the PCB 103. When the light-emitting element(s) 107 light up, light 301 projects into the interior chamber 201A in a substantially downward orientation. When the housing, container or vessel 201 houses or contains an article or substance, depending upon the physical properties of such article or substance, the top-mounted light-emitting element(s) 107 would emit light 301 that projects in a substantially downward orientation and through and/or around the article or substance contained therein to thereby illuminate the article or substance such that it may be visible and/or visually enhanced. In this case, the housing, container or vessel 201 may be constructed of one or more materials that permit the light emitted from the light-emitting element(s) 107 to be at least partially emitted through the top portion 201D, e.g., and optionally one or more walls 201B, of the housing, container or vessel 201 and to be visible from an area external to the housing, container or vessel 201. For instance, with the top portion 201D, and optionally one or more walls 201B, constructed of one or more translucent or transparent plastics, the light emitted from the light-emitting element(s) 107 would light up, for instance, an article or a fluid substance housed or contained within the housing, container or vessel 201 such that the article or fluid substance would be light-enhanced and the lighted article or the lighted fluid substance would be visible from an area external to the housing, container or vessel 201.

The housing, container or vessel 201 of the packaging system 200 may include or contain one or more devices, mechanisms, structures or other means by which the illuminating device 100 is contained or suspended or otherwise disposed within the interior chamber 201A of the housing, container or vessel 201. For instance, the illuminating device 100 may be suspended within an area of the interior chamber 201A to dispose the illuminating device 100 substantially along a middle, upper or lower portion of the interior chamber 201A with one or more devices, mechanisms, structures or other means that are constructed and arranged to secure the illuminating device 100 at one or more locations along one or more interior surfaces of the housing, container or vessel 201 that help to define and to configure the interior chamber 201A. Alternatively, or additionally, an illuminating device 100 may be disposed along an exterior surface of the housing, container or vessel 201 by one or more devices, mechanisms, structures or other means to secure the illuminating device 100 at one or more locations along the exterior surface of the housing, container or vessel 201.

In addition, the packaging system 200 and, in particular, the housing, container or vessel 201 may be constructed and arranged and/or sized such that two or more illuminating devices 100, e.g., a top-mounted device 100 as shown in FIG. 4A and a bottom-mounted device 100 as shown in FIG. 4B, may be mounted or connected to the housing, container or vessel 201 such that the light-emitting element(s) 107 are positioned to emit light 301 into the interior chamber 201A, e.g., in a substantially upward orientation and in a substantially downward orientation. Alternatively, or additionally, the packaging system and, in particular, the housing, container or vessel 201 may be constructed and arranged and/or sized such that two or more illuminating devices 100 may be mounted or connected to the housing, container or vessel 201 along one or more exterior surfaces of one or more walls 201B of the housing, container or vessel 201, e.g., to position the lighting element(s) 107 to project light 301 at a substantially inward orientation and/or at a substantially outward orientation relative to the interior chamber 201A and/or the one or more walls 201B of the housing, container or vessel 201. Further, the packaging system 200 and, in particular, the housing, container or vessel 201 may be constructed and arranged and/or sized such that one illuminating device 100 is positioned within the interior chamber 201A, e.g., such that the light-emitting element(s) 107 are positioned to emit light 301 that projects in a substantially upward or downward orientation relative to the PCB 103 or substantially in any other orientation relative to the interior surfaces of the one or more walls 201B, and a second or more illuminating devices 100 are positioned at one or more locations along an exterior surface of one or more walls 201B of the housing, container or vessel 201. The invention is not limited in this respect and the packaging system 200 and/or the housing, container or vessel 201 may be constructed and arranged and/or sized such that it may accept and position one or more illuminating devices 100 at any of a variety of exterior or interior positions relative to the interior chamber 201A and/or the one or more walls 201B of the housing, container or vessel 201 and may further include any of a variety of devices, mechanisms, structures or other means to mount, connect or other position the one or more illuminating devices 100 such that the light-emitting element(s) 107 project light 301 in any of a number orientations relative to the PCB 103 and/or the one or more walls 201B.

Referring to FIG. 4D, in the preferred embodiment, the housing, container or vessel 201 of the packaging system 201 along the bottom portion 201C and/or along the top portion 201D is configured and is sized such that the housing 101 of the illuminating device 100 mounts to or connects to the portion 201C and 201D of the housing, container or vessel 201. In one configuration of the preferred embodiment, the illuminating device 100 may be removably or permanently mounted or connected to the bottom portion 201C and/or the top portion 201D. Removably mounting or connecting the illuminating device 100 to the housing, container or vessel 201 would permit one or more batteries, disposed within the housing 101 of the illumination devices 100 as the power source(s) 102, to be removed from the illuminating device 100, e.g., for purposes of proper disposal or replacement of such power source(s) 102. In addition, as shown in FIG. 4D, the PCB 103 may be constructed and arranged for removable connection to one or more of the other components of the illuminating device 100 to permit removal of the PCB 103 from the interior chamber 101A.

Referring to FIGS. 5 and 6, other perspective views of the packaging system 200 including the illuminating device 100 are shown. As described with reference to FIGS. 3A and 3B, the integrated circuit(s) 106 of the illuminating device 100 are configured with programmed or programmable logic to enact a lighting pattern or cycle whereby the light-emitting element(s) 107 emit light in a pattern or cycle. In the preferred embodiment, the integrated circuit(s) 106 enact an oscillating lighting pattern or cycle whereby the integrated circuit(s) provide the light-emitting element(s) 107 with pulse width modulation signals to thereby provide electrical current to the light-emitting element(s) 107 after expiration of a given period of time such that the light-emitting elements(s) emit light 301 periodically and intermittently an oscillating pattern or cycle. For instance, the oscillating lighting pattern or cycle the integrated circuit(s) 106 enact causes the light-emitting element(s) 107 to emit light 301 for a given period of time, e.g., about 2 to about 3 seconds, and then causes the light-emitting element(s) 107 to shut-off or to go dark for a subsequent period of time, e.g., about 15 to about 25 seconds. After the expiration of the subsequent period of time, where the elapsing time of such period is counted by the oscillating circuit R2 as described above, the oscillating circuit R2 causes the integrated circuit(s) 106 to send pulse modulated signals to the light-emitting element(s) 107 to cause the light-emitting element(s) 107 to emit light once again. Where the packaging system 200 in which the illuminating device 100 is incorporated, or the illuminating device 100 itself, is not disposed in a certain position, e.g., an upright position, the rolling switch of 320 does not complete the lighting circuits 300 and, as a result, the electrical current to the integrated circuit(s) 106 is cut off. The rolling switch 320 thereby conserves the electrical power of the power source(s) 102, e.g., one or more DC batteries, of the illuminating device 100, such that, where the packaging system 200 and/or the illuminating device 100 are not to be presented, displayed or used, e.g., are being stored and/or transported, the rolling switch 320 prevents electrical power of the power source(s) 102 from flowing to the integrated circuit(s) 106 and the oscillating lighting pattern or cycle is not enacted to thereby conserve the electrical power of the power source(s) 102 until such time as the lighting pattern or cycle is required or desired.

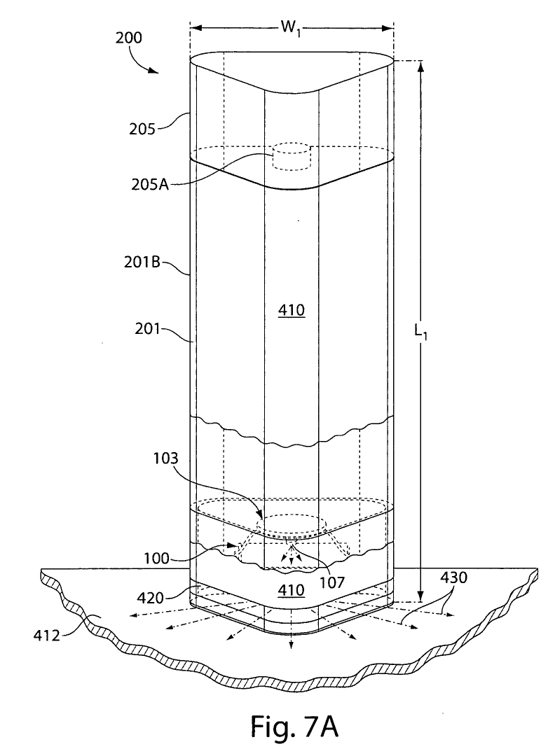

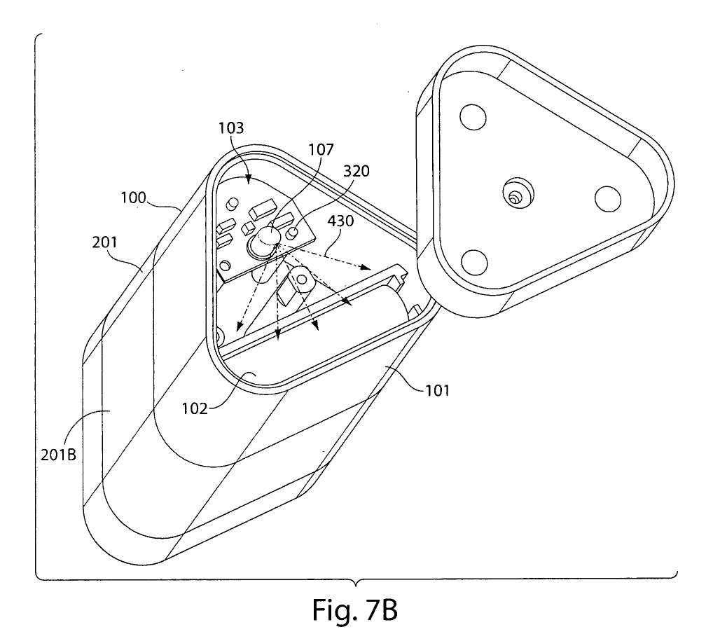

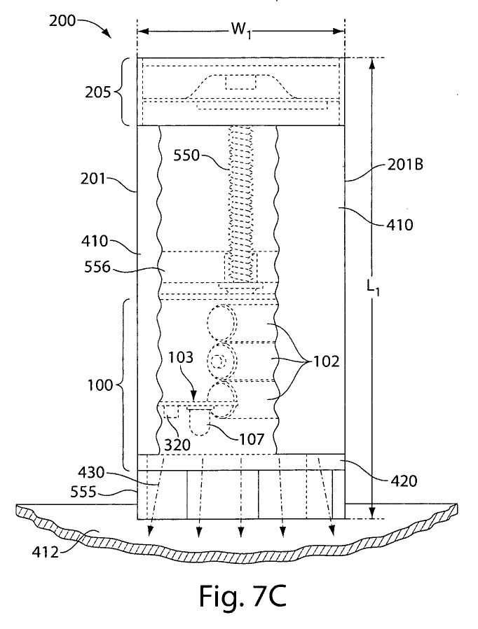

Referring to FIGS. 7A-7C, other configurations of the product packaging system 200 in which the illuminating device 100 may be incorporated include packaging systems 200 including a cap or top 205, and a label, sheath, wrapping or other material 410 covering an exterior surface of the housing, container or vessel 201 and extending almost the entire length L₁ of the housing, container or vessel 201 to prevent the light which the light-emitting element(s) 107 emit from transmitting or reflecting through one or more walls 201B of the housing, container or vessel 201. Alternatively, or additionally, the exterior and/or interior surfaces of one or more walls 201B of the housing, container or vessel 201 may include a surface treatment that prevents light the light-emitting element(s) 107 emit from transmitting or reflecting through the one or more walls 201B. As shown in FIGS. 7A and 7C, such label, sheath, wrapping or other material 410, and/or surface treatment 410, may be applied to the exterior and/or interior surface of one or more walls 201B to extend nearly the entire length L₁ of the housing, container or vessel 201, while leaving an exposed portion 420 of the one or more walls 201B located proximate to a bottom of the housing, container or vessel 201 uncovered and/or untreated, such that, the light 430 the light-emitting element(s) 107 emit transmits or reflects through the exposed or uncovered portion 420 of the one or more walls 201B. The light 430 shining through the exposed or uncovered portion 420 may be reflected on a surface 412 on which the product packaging system 200 is positioned or located such that the packaging system 200 lights up a portion of the surface 412. As shown in FIGS. 7A and 7B, in such configurations, the PCB 103 of the illuminating device 100 is disposed within the housing 101 such that the light-emitting element(s) 107 project from the PCB 103 in a downward orientation relative to the PCB 103 and/or the housing, vessel or container 201; hence, the light emitted from the light-emitting element(s) 107 transmits and reflects in a substantially downward orientation and toward the exposed or uncovered portion 420 and through the exposed or uncovered portion 420.

In some embodiments, the exposed or uncovered portion 420 of the one or more walls 201B extends along the entire circumference, perimeter, or width W₁ of the housing, vessel or container 201, depending upon the shape and configuration of the housing, vessel or container 201, such that, the light 430 transmitting or reflecting through the exposed or uncovered portion 420 creates a lighting effect, e.g., a halo-shaped or circle of light 430 or other shaped light 430, about the exterior of the housing, container or vessel 201. In such cases, the exposed or uncovered portion 420 is constructed of one or more translucent or transparent materials having clarity sufficient to enable the light 430 to transmit or to reflect through the exposed or uncovered portion 420. In such configurations, the product packaging system 200 illuminates, or provides a lighting effect along, the surface 412 on which it is positioned or located to enhance and/or to draw attention to its position or location. With respect to employing such product packaging systems 200 for consumer products or other products, such systems 200 enhance and draw consumer or end-user attention to the location of the product packaging 200, and thereby the one or more products contained therein. With respect to employing such product packaging systems 200 for consumer products or other products, as described above, such systems 200 draw consumer or end-user attention to the location of the packaging system 200 and enhance the one or more products contained therein. The packaging system 200 and the illuminating device 100 thereby enhance the one or more products and draw the attention of consumers and end-user to the location of such products on retail shelves and displays, and further help to distinguish such product(s) from other products that are located on the same or proximate shelves or displays. One of ordinary skill in the art will anticipate that the configurations of the product packaging system 200 and the illuminating device 100 shown in FIGS. 7A-7C may also be achieved by mounting or connecting the illuminating device 100 to the top portion 201D of the housing, container or vessel 201 and similarly creating an exposed or uncovered portion 420 adjacent to the top of the product packaging system 200.

With further reference to FIGS. 7A-7C, the product packaging system 200, as mentioned, may be used for any of a variety of products, including articles or substances. For instance, the product packaging system 200 shown in FIG. 7A is conducive to containing or housing articles, as well as fluid, solid or semi-solid substances, and may be further configured to dispense such articles and substances. In another instance, the product packaging system 200 shown in FIG. 7B is conducive to containing and to dispensing a solid, semi-solid or fluid substance, e.g., deodorant or antiperspirant, whereby a central rotating screw or spine 550 helps to deliver the substance to the top portion 201D of the housing, container or vessel 201 to deliver the substance, e.g., when a top 205 is removed from the housing, container or vessel 201. As the substance is depleted, the screw or spine 550 may be rotated using a actuator 555 along the bottom of the housing, vessel or container 201 to cause a pusher 556 to push the substance upward toward the top 201D of the housing, container or vessel 201 to provide access to the substance, e.g., as the substance is depleted through use.

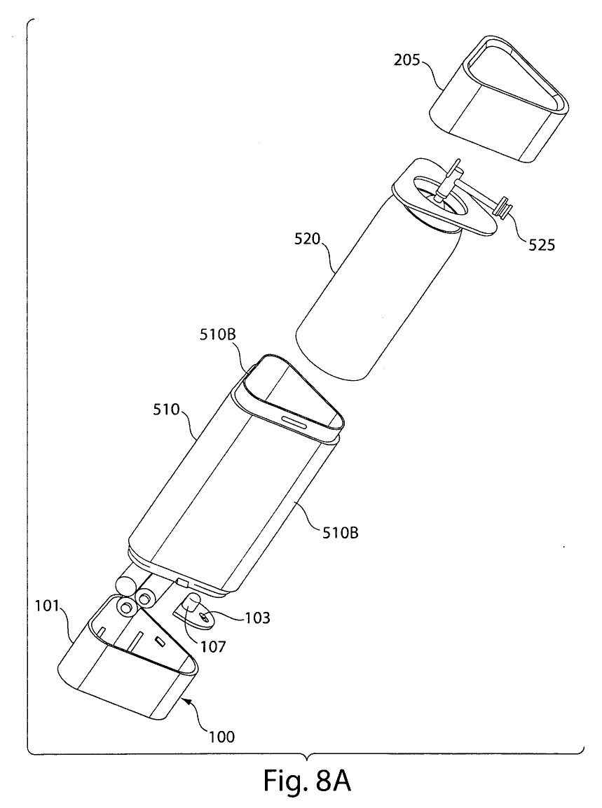

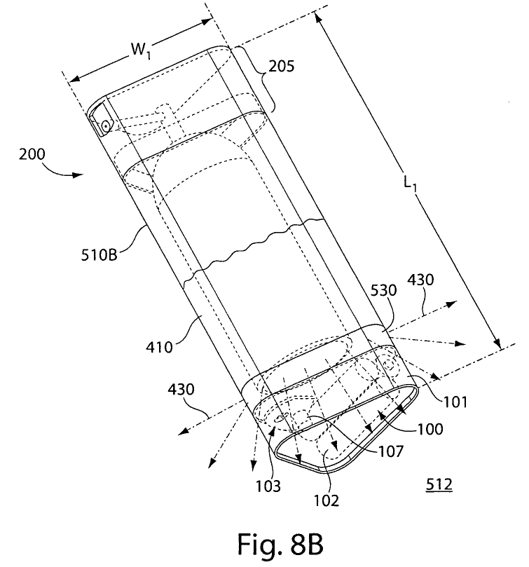

Referring to FIGS. 8A and 8B, in some configurations of the product packaging system 200 according the invention, the system 200 may include a housing, container or vessel 510 constructed and arranged to house or contain a pressurized container or cylinder 520. The pressurized or non-pressurized container or cylinder 520 is constructed and arranged to contain and to dispense a gas or fluid product, or other contents. The container or cylinder 520 includes a spray nozzle 525 for dispensing the product or contents from the container or cylinder 520. The housing, container or vessel 510 and/or the packaging system 200 are further constructed and arranged to dispense the gas or fluid product or contents from the container or cylinder 510. These configurations of the product packaging system 200 may incorporate one or more illuminating devices 100 as shown. As described above with respect to FIG. 7, the product packaging system 200 constructed and arranged to contain and to operate the container or cylinder 520 may further include a label, sheath, wrapping or other material 410 covering an exterior surface of the housing, container or vessel 510 and extending almost the entire length L₁ of the housing, container or vessel 510 to prevent the light the light-emitting element(s) 107 emit from transmitting or reflecting through one or more walls 510B of the housing, container or vessel 510. Alternatively, or additionally, the exterior and/or interior surfaces of one or more walls 510B of the housing, container or vessel 510 may include a surface treatment that prevents light the light-emitting element(s) 107 emit from transmitting or reflecting through the one or more walls 201B. As shown in FIG. 8B, such label, sheath, wrapping or other material 410, and/or surface treatment 410, may be applied to the exterior and/or interior surface of one or more walls 510B to extend nearly the entire length L₁ of the housing, container or vessel 510, while leaving an exposed portion 530 of the one or more walls 510B located proximate to a top portion of the illuminating device 100 and/or a bottom of the housing, container or vessel 510 uncovered and/or untreated, such that, the light 430 the light-emitting element(s) 107 emit transmits or reflects through the exposed or uncovered portion 530 of the one or more walls 510B. The light 430 shining through the exposed or uncovered portion 530 may be reflected on a surface 512 on which the product packaging system 200 is positioned or located such that the packaging system 200 lights up the surface 512. In some embodiments, the exposed or uncovered portion 530 of the one or more walls 201B extends along the entire circumference, perimeter, or width W₁ of the housing, vessel or container 510, depending upon the shape and configuration of the housing, vessel or container 510, such that, the light 430 transmitting or reflecting through the exposed or uncovered portion 530 creates, e.g., a halo-like or circle of light 430. In such cases, the exposed or uncovered portion 530 is constructed of one or more translucent or transparent materials to enable the light 430 to transmit or to reflect through the exposed or uncovered portion 530. In such configurations, the product packaging system 200 illuminates the surface 512 on which it is positioned or located to enhance and/or to draw attention to its position or location. With respect to employing such product packaging systems 200 for consumer products or other products, as described above, such systems 200 draw consumer or end-user attention to the location of the packaging system 200 and enhance the one or more products contained therein. The packaging system 200 and the illuminating device 100 thereby enhance the one or more products and draw the attention of consumers and end-user to the location of such products on retail shelves and displays, and further help to distinguish such product(s) from other products that are located on the same or proximate shelves or displays.

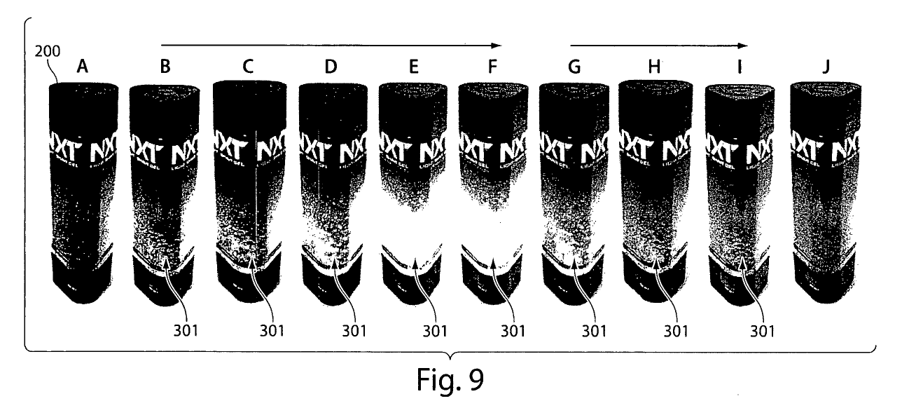

Referring to FIG. 9, and with further reference to FIGS. 3A and 3B, in another aspect, the invention provides a method 600 of illuminating the product packaging system 200 according to the invention in accordance with an oscillating lighting pattern or cycle. The method 600 is exemplary and includes the stages shown in FIG. 9, including Stages A thru J. The method 600, however, is exemplary only and not limiting, and may be altered, e.g., by having stages added, removed, altered, or rearranged. Stages A thru J illustrate the oscillating lighting pattern or cycle described above that the integrated circuit(s) 106 and the rolling switch 320 of the illuminating device 100 implement to intermittently light up the packaging system 200 and the contents contained therein. The invention is not limited in this respect and anticipates that other lighting patterns or cycles may be implemented by the integrated circuit(s) 106 and/or the rolling switch 320. As described above with respect to FIGS. 3A and 3B, when the packaging system 200, or the illuminating device 100 alone, is positioned in a certain position, such as an upright position, the rolling switch 320 completes the electrical circuits 300 and electrical current flows from the power source(s) 102 to the light-emitting element(s) 107 to thereby cause the element(s) 107 to light up or “flare.” As shown in FIG. 9, at Stage A, the packaging system 200 is not lit up and dark, e.g., which represents a “dark” phase of the oscillating lighting pattern or cycle during which the oscillating circuit 310 counts a given period of elapsing time, e.g., in seconds. Upon the expiration of Stage A or when the oscillating circuit 310 has counted the period of elapsing time, e.g., of about 15 seconds or about 25 seconds, the integrated circuit(s) 106 produce and transmit PWM signals to the light-emitting element(s) 107 and the element(s) 107, at Stage B, begin lighting. The light 301 emitted from the element(s) 107 begins to transmit or reflect from the element(s) 107 in a substantially upwardly orientation, such that, the light 301 reflects or passes through and/or around the one or more products or contents contained within the packaging system 200. At Stages B thru Stage F, the light 301 passes through and/or around the one or more products or contents within the packaging system 200, such that, at Stage F, a substantial portion of the one or more products or contents are light-enhanced by the light 301. In addition, as the light 301 transmits and reflects upwardly through the packaging system 200, the light 301 is emitted from the element(s) 107 with an increasing light intensity from Stage B thru Stage F, as shown by arrow 311 in FIG. 9. The light-emitting element(s) may remain lit up from Stage B thru Stage F for a given period of time, e.g. from about 2 seconds to about 3 seconds, until electrical current to the light-emitting elements(s) 107 is depleted and the light 301 begins to extinguish at Stage G thru Stage I, as shown by arrow 313 in FIG. 9, until the light-emitting element(s) 107 are no longer charged at Stage J. Stage J represents the beginning of a given period of elapsing time, whereby the oscillating circuit 310 is set/reset and counts the given period of elapsing time. Upon the expiration of the given period, the integrated circuit(s) 106 send PWM signals once again to the light-emitting element(s) 107 to charge the element(s) 107 to light up or “flare,” repeating the lighting pattern or cycle to thereby cause the illuminating device 100 to intermittently light up the packaging system 200.

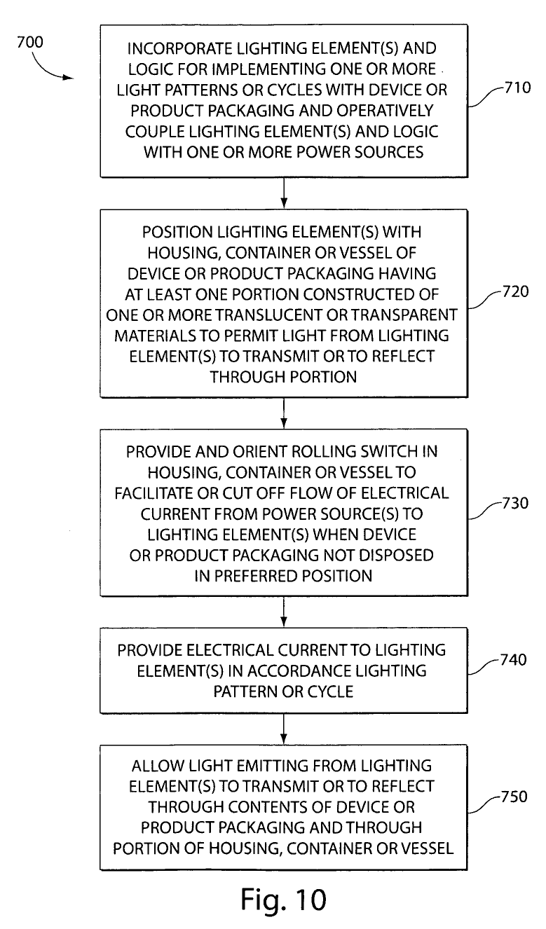

Referring to FIG. 10, and with further reference to FIGS. 1A-9, a block flow diagram is provided to illustrate another aspect of the invention that provides a method 700 of illuminating a device or a product packaging and includes the stages shown. The method 700, however, is exemplary only and is not limiting. The method 700 can be altered, e.g., by having stages added, removed or rearranged.

At stage 710, incorporate one or more light-emitting elements 107 and programmed or programmable logic, e.g., the integrated circuits(s) 106, which implements one or more lighting patterns or cycles, with the interior and/or the exterior of the device 100 or the product packaging system 200, and operatively couple the element(s) 107 and logic with one or more power sources 106.

At stage 720, position the element(s) 107, logic and power source(s) 106 within the housing, container or vessel 101 and 201 of the device 100 and the product packaging system 200 configured with a portion 420 and 530 constructed of one or more translucent or transparent materials having clarity sufficient to transmit or to reflect light the light-emitting element(s) 107 emit from the interior and/or through the exterior of the device 100 or the product packaging system 200 through of the housing, container or vessel 101 and 201.

At stage 730, provide and orient the rolling switch 320 to cut off flow of electrical current to the light-emitting element(s) 107 in the event the device 100 and/or the packaging system 200 is/are not in a preferred position and thereby the rolling switch 320 is not in the preferred position to discontinue lighting of the light-emitting element(s) 107, e.g., when lighting is not required or desired.

At stage 740, provide electrical current from the power source(s) 102 to the light-emitting element(s) 107 in accordance with one of the one or more lighting patterns or cycles.

At stage 750, allow the light-emitting element(s) 107 to emit light in accordance with the lighting pattern or cycle implemented to transmit or to reflect light through and/or around the one or more products contained within the packaging system 200 and/or through the portion 420 and 520 to visually enhance the one or more products and/or the product packaging system.

Having thus described at least one aspect of the invention, various alterations, modifications and improvements will readily occur to those skilled in the art. Such alterations, modifications and improvements are intended to be within the scope and spirit of the invention. Accordingly, the foregoing description is by way of example only and is not intended as limiting.

What is claimed is:

1. An illuminating product packaging system comprising:
an enclosed vessel, the configuration of the interior of the enclosed vessel defining an interior chamber configured and sized to contain one or more articles or substances;
an opening device disposed along one end of the enclosed vessel and constructed and arranged for releasably connecting to the enclosed vessel and substantially covering an opening of the enclosed vessel configured and sized to provide fluid communication between the interior chamber and an area external to the enclosed vessel;
an illuminating device disposed along another end of the enclosed vessel opposite to the opening device, the illuminating device including one or more light-emitting elements and configured with programmed or programmable logic to implement one or more lighting patterns or cycles that cause the one or more light-emitting elements to light up in accordance with a lighting pattern or cycle, wherein
at least a portion of the enclosed vessel is constructed of one or more translucent or transparent materials that permit light emitted from the one or more light-emitting elements to transmit or reflect to an area external to the enclosed vessel and to enable visual inspection of the one or more products contained within the enclosed vessel from an area external to the enclosed vessel such that the one or more products are enhanced by the emitted light.
